(19) United States
(12) Patent Application Publication
(10) Pub. No.: US 2025/0188353 A1
(43) Pub. Date: Jun. 12, 2025

(54) SYSTEMS AND METHODS FOR CAPTURING GREENHOUSE GASES FROM COKE PRODUCTION FACILITIES

(71) Applicant: SUNCOKE TECHNOLOGY AND DEVELOPMENT LLC, Lisle, IL (US)

(72) Inventors: John Francis QUANCI, Haddonfield, NJ (US); John Michael RICHARDSON, Devon, PA (US)

(21) Appl. No.: 18/971,647

(22) Filed: Dec. 6, 2024

Related U.S. Application Data
(60) Provisional application No. 63/606,660, filed on Dec. 6, 2023.

(51) Int. Cl. C10B 41/08; B01D 53/14; B01D 53/18; B01D 53/34; B01D 53/48; B01D 53/62

(52) U.S. Cl. CPC C10B 41/08; B01D 53/1425; B01D 53/1475; B01D 53/18; B01D 53/343; B01D 53/48; B01D 53/62; B01D 2257/302; B01D 2257/504; B01D 2258/0283

(57) ABSTRACT

A system for capturing carbon dioxide from flue gas produced by a coke oven includes a coke oven system and a capture system. The coke oven is configured to process coal to produce coke and a flue gas comprising carbon dioxide. The coke oven includes an induced draft fan positioned downstream of the coke oven. The induced draft fan is configured to provide a vacuum to the coke oven and move the flue gas away from the coke oven. The coke oven system also includes a stack open to atmosphere and downstream of the induced draft fan. The capture system is fluidically coupled to the coke oven system at a point between the coke oven and the stack. The capture system is configured to remove carbon dioxide from the flue gas.

### CROSS-REFERENCE TO RELATED APPLICATION(S)

The present application claims the benefit of U.S. Provisional Patent Application No. 63/606,660, filed Dec. 6, 2023, the disclosure of which is incorporated herein by reference in its entirety.

### TECHNICAL FIELD

This present disclosure relates to systems and methods for capturing greenhouse gases from coke production facilities. Particular embodiments of the present disclosure related to capturing and removing carbon dioxide from flue gas produced during the coking process.

### BACKGROUND

Coke is a solid carbon fuel and carbon source used to melt and reduce iron ore in the production of steel. In one process, known as the “Thompson Coking Process,” coke is produced by batch feeding pulverized coal to an oven that is sealed and heated to very high temperatures for twenty-four to forty-eight hours under closely-controlled atmospheric conditions. Coking ovens have been used for many years to convert coal into metallurgical coke. During the coking process, finely crushed coal is heated under controlled temperature conditions to devolatilize the coal and form a fused mass of coke having a predetermined porosity and strength. Because the production of coke is a batch process, multiple coke ovens are operated simultaneously.

Coal particles or a blend of coal particles are charged into hot ovens, and the coal is heated in the ovens in order to remove volatile matter (VM) from the resulting coke. Horizontal heat recovery (HHR) ovens operate under negative pressure and are typically constructed of refractory bricks and other materials, creating a substantially airtight environment. The negative pressure ovens draw in air from outside the oven to oxidize the coal's VM and to release the heat of combustion within the oven.

In some arrangements, air is introduced to the oven through damper ports or apertures in the oven sidewall or door. In the crown region above the coal-bed, the air combusts with the VM gases evolving from the pyrolysis of the coal. However, the buoyancy effect, acting on the cold air entering the oven chamber, can lead to coal burnout and loss in yield productivity. Specifically, the cold, dense air entering the oven falls towards the hot coal surface. Before the air can warm, rise, combust with volatile matter, and/or disperse and mix in the oven, it comes into contact with the surface of the coal bed and combusts, creating “hot spots.” These hot spots create a burn loss on the coal surface, as evidenced by the depressions formed in the coal bed surface. Accordingly, there exists a need to improve combustion efficiency in coke ovens.

In many coking operations, the draft of the ovens is at least partially controlled through the opening and closing of uptake dampers. However, traditional coking operations base changes to the uptake damper settings on time. For example, in a forty-eight hour cycle, the uptake damper is typically set to be fully open for approximately the first twenty-four hours of the coking cycle. The dampers are then moved to a first partially restricted position prior to thirty-two hours into the coking cycle. Prior to forty hours into the coking cycle, the dampers are moved to a second, further restricted position. At the end of the forty-eight hour coking cycle, the uptake dampers are substantially closed. This manner of managing the uptake dampers can prove to be inflexible. For example, larger charges, exceeding forty-seven tons, can release too much VM into the oven for the volume of air entering the oven through the wide open uptake damper settings. Combustion of this VM-air mixture over prolonged periods of time can cause the temperatures to rise in excess of the not to exceed (NTE) temperatures, which can damage the oven. Accordingly, there exists a need to increase the charge weight of coke ovens without exceeding NTE temperatures.

Heat generated by the coking process is typically converted into power by heat recovery steam generators (HRSGs) associated with the coke plant. Inefficient burn profile management could result in the VM gases not being burned in the oven and sent to the common tunnel. This wastes heat that could be used by the coking oven for the coking process. Improper management of the burn profile can further lower the coke production rate, as well as the quality of the coke produced by a coke plant. For example, many current methods of managing the uptake in coke ovens limits the sole flue temperature ranges that may be maintained over the coking cycle, which can adversely impact production rate and coke quality. Accordingly, there exists a need to improve the manner in which the burn profiles of the coking ovens are managed in order to optimize coke plant operation and output.

Carbon dioxide (CO₂) capture from flue gas is essential in efforts to mitigate climate change. Flue gas is produced by the combustion of fossil fuels in power plants, industrial processes, and other facilities, and contains a mixture of gases including carbon dioxide, nitrogen, water vapor (H₂O), and trace amounts of other pollutants. Captured carbon dioxide can be utilized in various applications, such as enhanced oil recovery, biofuel production, production of chemicals, or in building materials like concrete.

### BRIEF DESCRIPTION OF THE DRAWINGS

Features, aspects, and advantages of the presently disclosed technology may be better understood with regard to the following drawings.

FIGS. 1-4 are diagrams illustrating systems for capturing greenhouse gases from flue gas in accordance with embodiments of the present technology.

FIG. 5. is a diagram illustrating a capture system in accordance with embodiments of the present technology.

FIG. 6 is a diagram illustrating the system for capturing greenhouse gases from flue gas in accordance with embodiments of the present technology.

FIG. 7 is a flow diagram illustrating a process for capturing carbon dioxide from flue gas in accordance with some embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present disclosure relate to systems and methods for capturing greenhouse gases from flue gas produced by a system configured to process coal and/or produce coke. Carbon dioxide is a significant component in a flue gas emitted from the combustion of fossil fuels (e.g., coal) in coke oven processes, and is a primary greenhouse gas contributing to global climate change. Reduction of carbon dioxide emissions from the coke oven industry can have a significant environmental effect.

Embodiments of the present disclosure can capture carbon dioxide discharged by a coke oven system (e.g., a heat recovery system, a byproduct plant) for use in various industrial applications. Systems of the present disclosure can include a coke oven configured to process coal to produce coke and flue gas, an induced draft fan positioned downstream of the coke oven and configured to provide a vacuum to the coke oven, and a stack open to the atmosphere and downstream of the induced draft fan. The system further includes a carbon dioxide capture system fluidically coupled to the coke oven system at a point between the coke oven and the stack that is configured to remove carbon dioxide from the flue gas.

In the figures, identical or similar reference numbers identify generally similar, and/or identical, elements. Many of the details, dimensions, and other features shown in the figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Systems and Methods for Capturing Carbon Dioxide From Flue Gas

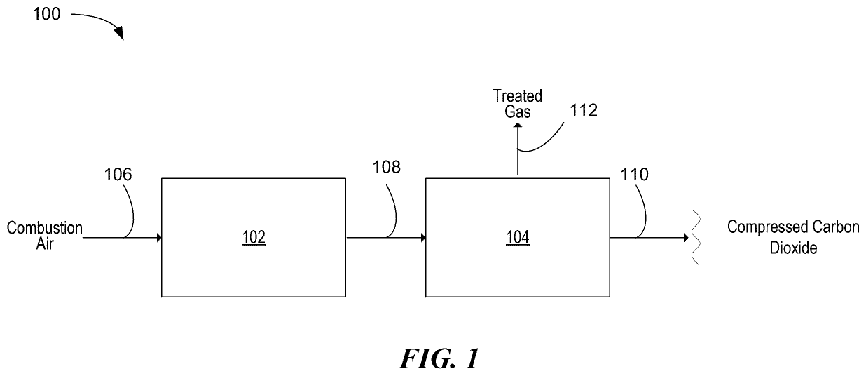

FIG. 1 is a diagram illustrating a system 100 for capturing carbon dioxide from flue gas in accordance with embodiments of the present technology. The system 100 includes a coke oven system 102, and a carbon dioxide capture system 104 (also referred to as “a capture system 104”) fluidically coupled to and downstream of the coke oven system 102. The coke oven system 102 is configured to process coal into coke via pyrolysis, and receives combustion air via a combustion air inlet 106 (e.g., damper ports or apertures of the coke oven sidewall or door). The combustion air combusts with the volatile matter gases evolving from the pyrolysis of the coal to produce heat and flue gas including carbon dioxide (e.g., a carbon dioxide-rich gas). The flue gas can be transmitted through a connector 108 (e.g., ducting, piping, a common tunnel, etc.) to the capture system 104. The capture system 104 is configured to treat the flue gas to separate carbon dioxide from the flue gas (e.g., a carbon-dioxide-lean gas). The separated carbon dioxide gas can be transmitted through a connector 110 (e.g., ducting, piping, etc.) to be processed into compressed carbon dioxide. The processed carbon dioxide can be stored and transported via pipelines to be used for further applications (e.g., for oil recovery, biofuel production, production of chemicals, or production of building materials). The treated gas (e.g., carbon dioxide-lean gas) can be removed from the system 100 via an outlet 112, e.g., into the atmosphere.

The capture system 102 can include membranes, oxyfuel combustion, absorption, adsorption, chemical looping combustion, calcium looping, and/or cryogenic capture. Absorption-based carbon dioxide capture technologies can include absorption into suitable solvents. Exemplary absorption solvents include aqueous amine solutions, potassium carbonate and sodium carbonate solutions, ammonia, ionic liquids, switchable solvents (e.g., based on pH or polarity) and physical solvents (e.g., methanol or glycols), metal-organic frameworks, hydrated ionic salts, or combinations thereof. The implementation of the capture system 104 in connection with the coke oven system 102 can reduce the carbon dioxide emissions from the release of flue gas as a byproduct of coke production.

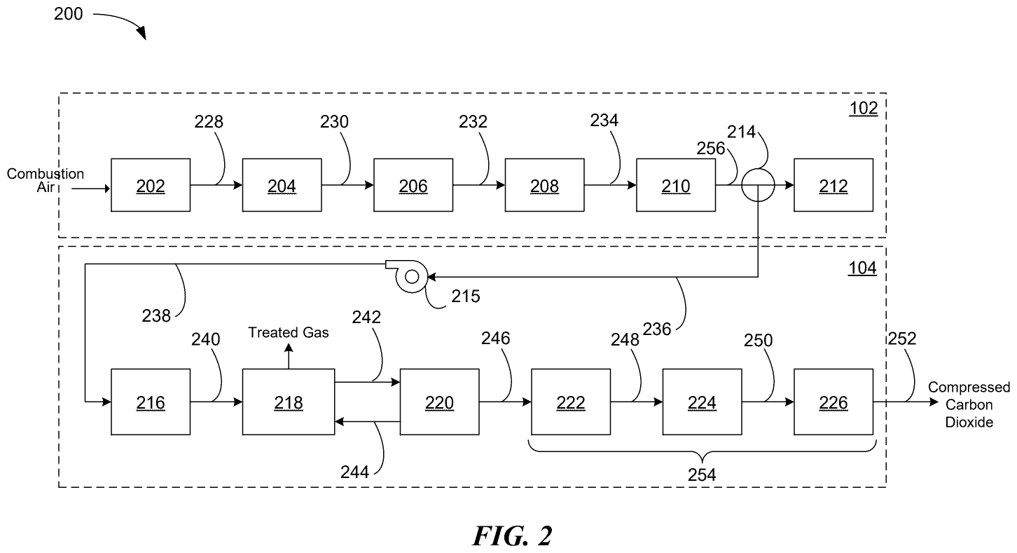

FIGS. 2-4 illustrate various exemplary configurations of the system 100 including the coke oven system 102 and the capture system 104. In addition to the components and systems described with respect to FIG. 1, the system 200, 300, 400 in FIGS. 2-4, respectively, can include additional components and/or systems. It is understood that the different configurations of FIGS. 2-4 are not limiting the scope of the disclosure.

FIG. 2 is a diagram illustrating a system 200 for capturing carbon dioxide from flue gas in accordance with embodiments of the present technology. The system 200 can correspond to the system 100 previously described. The system 200 includes the coke oven system 102 and the capture system 104, as described with respect to FIG. 1. The coke oven system 102 can include one or more coke ovens 202, one or more heat recovery steam generators (HRSGs) 204, a desulfurizer 206, a baghouse 208, an induced draft fan 210, and a stack 212. The capture system 104 can include a fan or blower 215, a pretreatment unit 216, an absorber 218, a solvent regenerator 220 (e.g., a stripper), and a compression unit 254. The compression unit 254 can include one or more of a low-pressure compressor 222, a dehydration system 224, and a high-pressure compressor 226. The capture system 104 is fluidically coupled to the coke oven system 102 by a tie-in 214 positioned between the induced draft fan 210 and the stack 212.

The coke oven 202 is configured to receive combustion air to process coal into coke. The induced draft fan 210 is configured to provide a vacuum to the coke oven 202 and move the flue gas from the coke oven 202 through the HRSG 204, desulfurizer 206, and baghouse 208 toward the stack 212, e.g., via connectors 228, 230, 232, 234, and 256. The HRSG 204 is configured to receive and cool the flue gas from the coke oven 202 via the connector 228. The HRSG 204 operates as a heat exchanger to capture the waste heat from the stream of hot flue gas coming from the coke oven 202 and uses it to generate steam. The desulfurizer 206 is positioned to receive the flue gas from the HRSG 204 via the connector 230, and can include a dry flue gas desulfurization (DFGD) system including a spray dryer absorber (SDA) for sulfur dioxides (e.g., sulfur dioxide (SO₂)). The desulfurizer 206 is configured to remove sulfur oxides, mercury, fly ash, and/or lime from the flue gas. Removing such particles can help with processing the flue gas via the capture system 104. The baghouse 208 is positioned to receive the flue gas from the desulfurizer 206 via the connector 232. The baghouse 208 (e.g., a baghouse filter) is configured to remove particulates (e.g., dust, smoke, and/or ash) from the flue gas. The induced draft fan 210 is positioned downstream from the baghouse 208 and is configured to move the flue gas toward the stack 212 and/or the capture system 104 via the connector 256. The stack 212 is configured to release the flue gas produced by the coke oven system 102 to the atmosphere.

The tie-in 214 is configured to adjoin the capture system 104 to the coke oven system 102. The tie-in 214 can comprise a valve or other mechanism that is switchable between different configurations to allow the flue gas to be moved to the stack 212 via the connector 256, or to bypass the stack 212 and direct the flue gas to the capture system 104. The tie-in 214 can include a series of double isolation dampers to minimize leakage and allow venting of the flue gas directly to the stack 212 any time the capture system 104 is taken offline for, e.g., maintenance, a scheduled shutdown or in the event of a high excursion where flows exceed the design flow for the carbon dioxide capture plant. The ductwork for directing the flue gas to the stack 212 and/or the capture system 104 can comprise uncoated carbon steel. A ductwork coating could be included to further reduce the risk of corrosion.

The fan 215 (e.g., a flue gas booster fan) is positioned to receive the flue gas from the coke oven system 102 via connectors 236 and 238 and further move the flue gas downstream to be processed by the capture system 104. The pretreatment unit 216 is positioned to receive the flue gas from the fan 215 and cool down and/or reduce the sulfur dioxide concentration. For example, the pretreatment unit 216 includes a Direct Contact Cooler (DCC) and/or a Flue Gas Quencher. The lower temperature and/or the reduced sulfur dioxide can increase the efficiency of carbon dioxide removal. For example, the pretreatment unit 216 can reduce the sulfur dioxide concentration to a concentration below or equal to 5 parts per million volume (ppmv). In instances where the pretreatment unit includes a quencher, the flue gas can pass through a counter-current packed tower, where contact cooling water is recirculated to cool the flue gas to approximately 100° F. The contact cooling water is cooled in a heat exchanger with service cooling water and returned to the quencher. A 25 wt % sodium hydroxide (NaOH) caustic solution can be added to the recirculated water as needed for additional SO₂ and sulfur trioxide (SO₃) removal. A portion of the recirculating water can be purged periodically as a blowdown stream to reduce the concentration of contaminants (e.g., residual particulates, sodium salts, and other soluble components) and maintain a stable liquid.

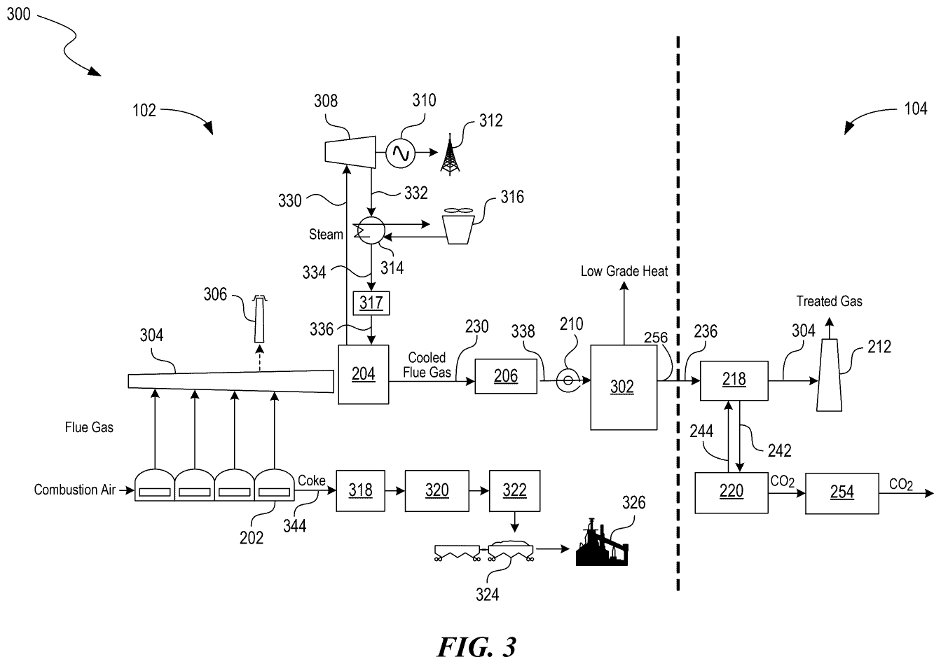

The flue gas treated by the pretreatment unit 216 is directed via a connector 240 to the absorber 218 (e.g., an absorber column). The absorber 218 is positioned to receive a carbon dioxide-absorbing solvent (e.g., amine solvent) from the solvent regenerator 220 via a connector 244 and enables the carbon dioxide from the flue gas to be absorbed into the solvent. For example, the absorber 218 can absorb or capture at least 75%, at least 80%, at least 85%, at least 90%, or at least 95% of the carbon dioxide in the flue gas. The absorber 218 can release the treated gas (e.g., carbon dioxide-lean gas) after the removal of the carbon dioxide into the atmosphere (e.g., via a stack). The solvent regenerator 220 is positioned to receive the solvent including the absorbed carbon dioxide gas from the absorber 218 via the connector 242. The solvent regenerator 220 (e.g., a stripper) is configured to remove the carbon dioxide and/or other volatile organic compounds from the solvent. The removed carbon dioxide is directed via the connector 246 to the compression unit 254, which is configured to dehydrate and compress the carbon dioxide to a fluid that can be transported via pipelines (e.g., a pipeline 252) to be stored and/or reused. The compression unit 254 can include the low-pressure compressor 222, the dehydration system 224, and the high-pressure compressor 226 fluidically coupled in a series by connectors 248 and 250. In some embodiments, the capture system 104 can be operated using the steam generated by the HRSG 204. The steam from the HRSG 204 can be transported to the capture system 104 via a connector and can, for example, be used as a power source by the compression unit 254. Also, in instances where the HRSG 204 includes or is coupled with a steam turbine generator (e.g., a turbine 308 in FIG. 3), the HRSG 204 can be used to provide electricity to the capture system 104.

FIG. 3 is a diagram illustrating a system 300 for capturing carbon dioxide from flue gas in accordance with embodiments of the present technology. The system includes many of the components described with respect to FIG. 2 as well as additional components and/or systems. Some of the components described with respect to FIG. 2 are excluded from FIG. 3 for clarity.

As described herein, the coke ovens 202 are configured to produce coke from coal. The coal can be moved from the coke ovens 202 to a wet quencher via a conveyer 344 (e.g., a belt or rail car). The coal can be processed by the wet quencher 318 and a screening and crushing unit 320 before being transported to a load-out unit 322. The wet quencher 318 is configured to cool the temperature of the coke received from the coke ovens 202. The screening and crushing unit 320 is configured to control the particle size of the coke based on screening and/or crushing operations. The load-out unit 322 refers to a facility for loading end product (coke having a desired particle size) onto transportation vehicles 324. The coke can then be transported to be used, e.g., in blast furnaces 326 or other operations.

The flue gas from the coke ovens 202 is transported via a connector 304 to the HRSG 204. The connector 304 can be coupled with an emergency vent stack 306 that allows relief of the flue gas. The HRSG 204 is configured to recover heat from the hot flue gas stream to generate steam. The steam is transported via the connector 330 to a turbine 308 coupled to a power generator 310 and a power grid 312 for converting and transporting the heat energy from the steam into energy applicable to the power grid 312. The cooled steam from the turbine 308 is transported via a connector 332 to a condenser 314 fluidically coupled with a cooling tower 316. The condenser 314 is configured to condense the steam into a liquid that can be received by a unit 317 via a connector 334 including feed water heaters, pumps, and/or deaerators, and forwarded by the unit 317 back to the HRSG 204 system via a connector 336.

In some embodiments, the coke oven system 102 includes a cooling dehydrator unit 302 downstream from HRSG 204, the desulfurizer 206, and the induced draft fan 210. The cooling dehydrator unit 302 can be configured to receive the flue gas from the induced draft fan 210 via a connector 338 and decrease the temperature and/or reduce moisture in the flue gas.

The capture system 104 is positioned to receive the flue gas from the cooling dehydrator unit 302 and process the flue gas to remove carbon dioxide as described with respect to FIG. 3. In some embodiments, the carbon dioxide from the absorber 218 can be redirected to the stack 212 via a connector 304 to be released into the atmosphere. In some embodiments, the carbon dioxide from the absorber 218 can be redirected to the atmosphere via different means (e.g., by a stack that is different from the stack 212).

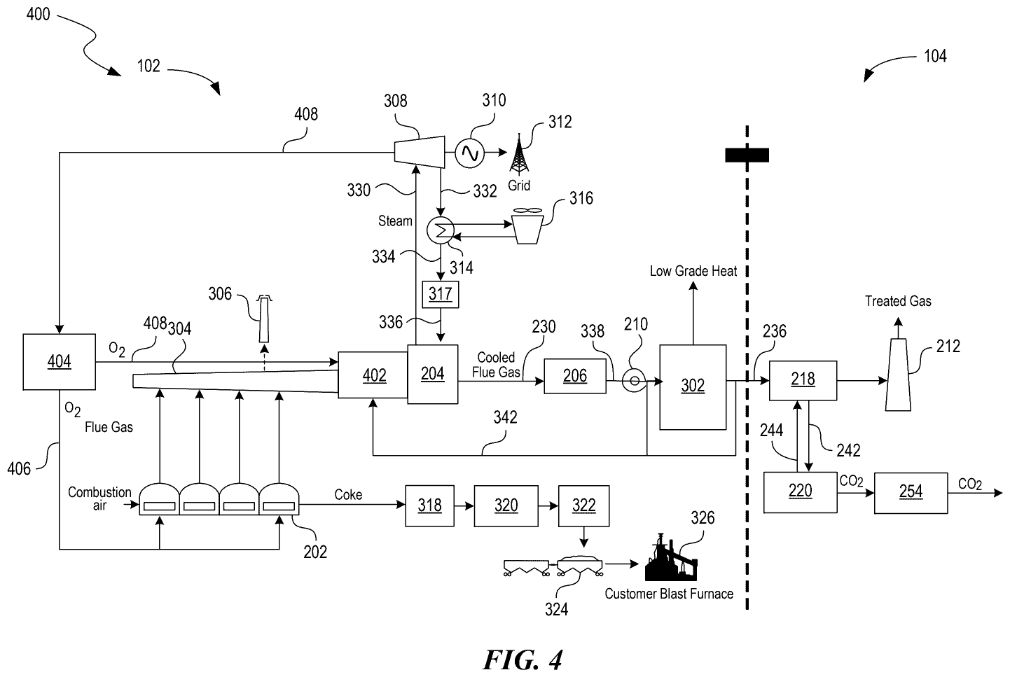

FIG. 4 is a diagram illustrating a system 400 for capturing carbon dioxide from flue gas in accordance with embodiments of the present technology. The system 400 includes many of the components described with respect to FIGS. 2 and 3, as well as additional components and/or systems. For example, the system 400 includes an air separation unit 404 and a combustion box 402. The air separation unit 404 is fluidically coupled to the coke ovens 202 via a connector 406, the combustion box 402 via a connector 408 (e.g., a common tunnel), and the turbine 308 via the connector 408. The coke oven system 102 includes a flue gas recirculation connector 342 that transports a portion of the flue gas from connection points before and/or after the cooler and dehydrator unit 302 back to the combustion box 402 that is positioned between the coke ovens 202 and the HRSG 204. The combustion box 402 can be configured to receive the portion of the flue gas for combustion and/or for acting as a gas cooling mechanism for the combustion box 402. The air separation unit 404 can be configured to provide oxygen or oxygen enrichment at various points of the combustion (e.g., to the combustion box 402 and/or the ovens 202), recycling a portion of the flue gas to be processed by the coke oven system 102 (e.g., via the connector 342), and introducing oxygen-enriched air or oxygen to the coke ovens 202. The oxygen enrichment can lower the nitrogen concentration at the coke oven system 102 thereby increasing the carbon dioxide concentration and enabling easier removal of the carbon dioxide from the system. The air separation unit 404 can receive steam and power to enable the air separation from the turbine 308 and/or the power generator 310. In some embodiments, the oxygen box is positioned at a base of the emergency vent stack 306.

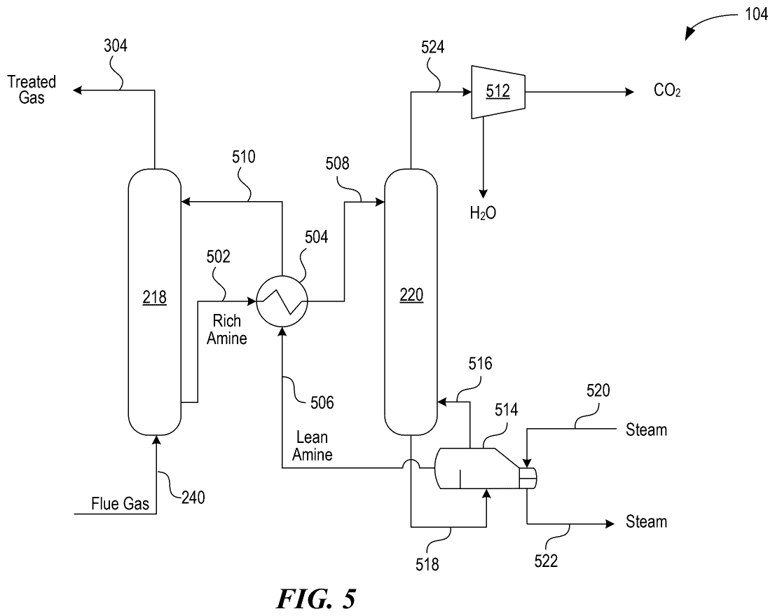

FIG. 5 is a diagram illustrating the capture system 104 in accordance with embodiments of the present technology. The capture system 104 is an amine treatment system that utilizes amine solvents that are commonly known to absorb carbon dioxide to remove carbon dioxide from a gas stream. Such amine solvents can include, for example, monoethanolamine (MEA), 2-amino-2-methylpropanol (AMP), methyldiethanolamine (MDEA), diglycolamine (DGA), and piperazine.

The system 104 includes the absorber 218 and the solvent regenerator 220. The absorber 218 in FIG. 5 can be a counter-current absorber column including a lower flue gas absorption section and an upper washing section. Several levels of packing, spray zones, and trays can facilitate the appropriate solvent-to-gas contact to ensure a high level of carbon dioxide absorption by the solvent. Cooled flue gas from the pretreatment unit 216 can enter the bottom section of the absorber 218 via the connector 240. The absorber 218 includes carbon dioxide-lean amine solvent that is provided to the absorber 218 from an outlet at the upper section via a connector 510. The temperature of the flue gas can increase as it passes through the absorber 218. The temperature is controlled by using interstage coolers or heat exchangers to cool the semi-rich solvent and return it to the absorber 218. Flue gas from the bottom section then passes through the absorber 218 to the upper section to minimize carbon dioxide and, optionally, other volatile organic compound (VOC) emissions. The treated gas (e.g., carbon dioxide-depleted flue gas) exits the absorber 218 through a stack located on top of the absorber column (e.g., the stack 212 shown in FIGS. 3 and 4). Flue gas leaves in a partially saturated state which may result in a visible plume of water droplets depending on ambient weather conditions. The amine solvent enriched (or saturated) with carbon dioxide and optionally by other VOCs exits the absorber 218 through an outlet at the bottom section via a connector 502.

The amine solvent enriched with the carbon dioxide from the absorber 218 is pre-heated by hot-lean solvent from the bottom of the solvent regenerator 220 column through a lean-rich cross-heat exchanger 504 before it enters the top of the counter-current solvent regenerator 220 column via a connector 508. The solvent regenerator 220 is fluidically coupled to a reboiler 514 via connectors 516 and 518. In the solvent regenerator 220, carbon dioxide from the amine solvent is desorbed by heating the amine solvent enriched with carbon dioxide to break the weak intermediate bond between the carbon dioxide and the amine solvent. The reboiler 514 utilizes low-pressure steam (e.g., via connectors 520 and 522) as the source of energy to transfer heat (indirectly) to vaporize water in the lean solvent. The generated water vapor rises through the regenerator providing energy to facilitate in stripping of the carbon dioxide and regenerating the amine solvent (e.g., the carbon dioxide-lean amine solvent). Hot-lean (or regenerated) solvent, which is free of carbon dioxide, exits from the bottom of solvent regenerator 220 and is cooled by lean-rich cross-heat reboiler 514 prior to entering back into the absorber 218 via a connector 506. This heat exchange helps to recover some of the energy used for regeneration, reducing the overall energy requirements of the process, especially in the regeneration stage. A mixture of carbon dioxide and steam exits the top of the regenerator via a connector 524 and passes through a condenser 512 to remove excess water vapor which can be returned to the solvent regenerator 220 as reflux.

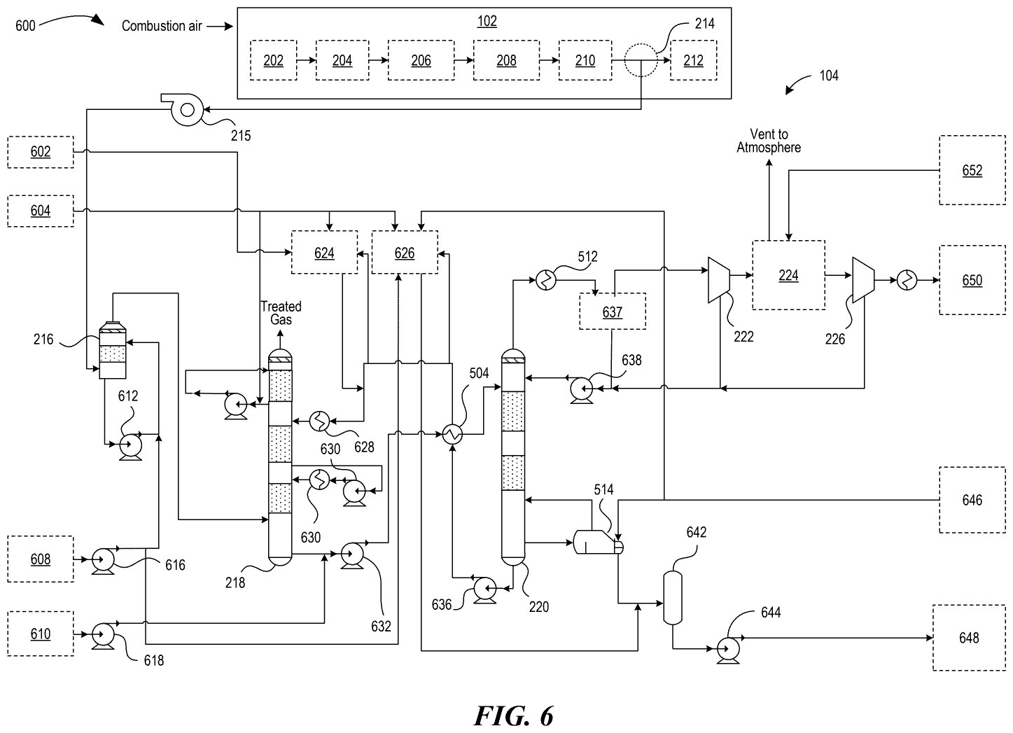

FIG. 6 is a system 600 for capturing carbon dioxide from flue gas, in accordance with embodiments of the present technology. The system 600 includes many features shown and described in previous systems (e.g., systems 200, 300, 400), as well as additional features. For example, as shown in FIG. 6, the system 600 includes a pretreatment unit 216 positioned to receive pressurized flue gas from the fan 215. The pretreatment unit 216, which can include a direct contact cooler or flue gas quench unit, concentrates carbon dioxide from the flue gas by removing moisture therefrom. In doing so, the pretreatment unit 216 can produce (i) a vapor stream exiting an upper portion of the pretreatment unit 216 and that is directed to an absorber 218, and (ii) a liquid stream exiting a bottom portion of the pretreatment unit 216 and that is either blown down to a cooling tower or recycled back to an intermediate portion of the pretreatment unit 216. In some embodiments, a caustic solution from a caustic solution source 608 and/or an amine solution from a solvent solution source 610 is combined with the liquid stream that is recycled to the intermediate portion of the pretreatment unit 216.

The absorber 218 effectively removes at least a portion of the carbon dioxide from the received vapor stream. In operation, as the vapor stream is cooled and it rises through the absorber 218, carbon dioxide is removed therefrom to form a depleted vapor stream exiting an upper portion of the absorber as treated gas. In some embodiments, the efficiency of the absorber 218 is enhanced by introducing a wash water treatment to an intermediate portion of the absorber 218 (e.g., by looping water through a wash water loop). Wash water treatment can be used to remove impurities and thereby improve the purity of the captured carbon dioxide. The wash water treatment can also be used to cool down the absorber 218.

A liquid carbon dioxide-rich stream exits a bottom portion of the absorber 218 and is directed to the solvent regenerator or stripper 220. In some embodiments, a solvent (e.g., an amine solution) from the solvent solution source 610 is combined with the liquid carbon dioxide-rich stream exiting the absorber 218. The carbon dioxide-rich stream is directed through one or more lean/rich heat exchangers 504 to the solvent regenerator 220 (e.g., a stripper). The solvent regenerator 220 is configured to remove the carbon dioxide and/or other volatile organic compounds from the solvent. In the solvent regenerator 220, carbon dioxide from the amine solvent is desorbed, e.g., by heating the amine solvent enriched with carbon dioxide to break the weak intermediate bond between the carbon dioxide and the amine solvent.

The carbon dioxide-lean solvent is recycled back to the absorber 218, via one or more lean/rich heat exchangers 504 and one or more coolers 628, through a bottom portion of the solvent regenerator 220. In some embodiments, at least a portion of the carbon dioxide-lean solvent is further filtered through a filtration system 624 and/or reclaiming system 626 before being recycled to the absorber 218. The reclaiming system 626 can remove chemical contaminants from the carbon dioxide-lean solvent (e.g., by a boiling process) while the filtration system 624 can remove suspended solid contaminants (e.g., iron sulfides or oxides, organic molecules generated by amine degradation, or carbon fines) from the carbon dioxide-lean solvent. In some embodiments, the filtration system 624 and the reclaiming system 626 use demineralized water (e.g., deionized water) from a demineralized water 604 for processing the solvent. The filtration system 624 can further receive instrument air (e.g., compressed air) from an instrument air source 602 to be used for the filtration process.

The solvent regenerator 220 is fluidically coupled to a reboiler 514. The reboiler 514 utilizes low-pressure steam received from a steam supply source 646 to transfer heat (e.g., indirectly) to vaporize water in the lean solvent. The generated water vapor rises through the solvent regenerator 220, providing energy to facilitate stripping of the carbon dioxide and regenerating the solvent (e.g., the carbon dioxide-lean amine solvent). The carbon dioxide-lean solvent exits from the bottom of solvent regenerator 220 and is cooled by lean-rich cross-heat reboiler 514 prior to being recycled back into the absorber 218. The steam from the reboiler 514 is recycled through a steam condensate drum 642 and a steam condensate return pump 644 as a condensate to a deaerator 648 which is configured to remove dissolved gases from the condensate.

Carbon dioxide removed from the carbon dioxide-rich solvent by the solvent regenerator 220, together with steam, exits an upper portion of the solvent regenerator 220 to a condenser 512 which removes excess water vapor. The excess water vapor can be returned to the solvent regenerator 220 as reflux through a reflux drum 637. The carbon dioxide is then directed to a compression unit including a low-pressure compressor 222, a dehydration system 224, and a high-pressure compressor 226. The compression unit can remove residual water from the carbon dioxide separated from the flue gas by the dehydration system 224. For example, the dehydration system 224 is a tri-ethylene glycol (TEG) dehydration system configured to receive TEG from a TEG source 652 and allow water from the carbon dioxide gas to be absorbed to the TEG. The compressed carbon dioxide is directed from the compression unit to a storage 650 (e.g., to be transported to further utility via a pipeline).

The system 600 can further include a plurality of fluidical pumps (e.g., pumps 612, 616, 618, 630, 632, 636, and 638), vents, valves, connectors, controllers, and/or other components that are used for operation of the system 600. For example, the pumps can be used to transfer fluids (e.g., gases or liquids) throughout the system.

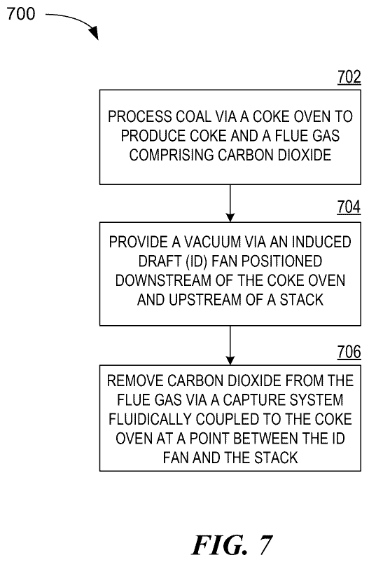

FIG. 7 is a flow diagram illustrating a method 700 for capturing carbon dioxide from flue gas in accordance with embodiments of the present technology. The method 700 can be performed by any of the systems 100, 200, 300, 400, 600 described with respect to FIGS. 1-6. In some embodiments, the method 700 can capture carbon dioxide from the flue gas with a recovery rate of at least 75%, at least 80%, at least 85%, at least 90%, or at least 95%.

The method 700 can include processing coal via a coke oven to produce coke and a flue gas comprising carbon dioxide (process portion 702). The coke oven can include the coke ovens 202 (FIG. 2) of the coke oven system 100 (FIG. 1) described herein. Processing the coal can include heating the coal in a coke oven to produce volatile matter (VM) and the flue gas.

The method 700 can further include providing a vacuum via an induced draft fan positioned downstream of the coke oven and upstream from a stack (process portion 704), thereby moving the flue gas away from the coke oven system. The induced draft fan can include the induced draft fan 210 (FIG. 2) and the stack can include the stack 212 (FIG. 2), which is open to the atmosphere. Providing the vacuum via the induced draft fan to move the flue gas from the coke oven can include providing the vacuum via the HRSG 204, the desulfurizer 206, the baghouse 208, and the induced draft fan 210 of the system 100 (FIG. 2).

The method 700 can further include removing carbon dioxide from the flue gas by a capture system fluidically coupled to the coke oven system at a point between the coke oven and the stack (process portion 706). The capture system can include the capture system 104 (FIG. 1). In some embodiments, the point where the capture system is fluidically coupled to the coke oven system is between the induced draft fan and the stack. The point where the capture system is fluidically coupled to the coke oven can correspond to the position of the tie-in 214 positioned between the induced draft fan 210 and the stack 212 (FIG. 2). The method 700 can further include directing the flue gas from the coke oven to the capture system by the tie-in. The tie-in can be switchable between a first configuration and a second configuration. When the tie-in is in the first configuration, the tie-in directs the flue gas from the coke oven to the capture system 104 (FIG. 2). When the tie-in is in the second configuration, the tie-in directs at least a portion of the flue gas from the coke oven to the stack 212 (FIG. 2).

In some embodiments, the method 700 includes causing carbon dioxide from the flue gas to be absorbed in a solvent (e.g., an amine solvent) to produce treated flue gas by an absorber. The absorber can include the absorber 218 (FIG. 2), and the treated gas, which is free or lean from carbon dioxide, can be released to the atmosphere via the stack 212 (FIG. 3). The method 700 can include providing the solvent to the absorber unit by a solvent generator. The solvent regenerator can include the solvent regenerator 220 (FIG. 2). The method 700 can also include receiving the solvent including the absorbed carbon dioxide by the solvent regenerator from the absorber unit. The solvent regenerator causes the carbon dioxide to be separated from the absorbing solvent.

In some embodiments, the method 700 includes compressing the carbon dioxide removed from the flue gas by a carbon dioxide compressor system. The carbon dioxide compressor system can include the carbon dioxide compression unit 254 (FIG. 2), and/or a low-pressure compressor, a high-pressure compressor, and a dehydration unit positioned between the low-pressure compressor and the high-pressure compressor (e.g., the low-pressure compressor 222, the dehydration system 224, and the high-pressure compressor 226 in FIG. 2). Compressing the carbon dioxide can cause residual water to be removed from the carbon dioxide separated from the flue gas by the dehydration unit.

In some embodiments, the method 700 includes cooling the flue gas from the coke oven and/or reducing moisture in the flue gas from the coke oven by a cooling dehydrator. The cooling dehydrator can include the cooling dehydrator unit 302 (FIG. 3), and can be positioned between the induced draft fan 210 (FIG. 3) and the point where the capture system is fluidically coupled to the coke oven system 104 (FIG. 3).

In some embodiments, the method 700 includes recovering heat from a stream of the flue gas by a heat recovery steam generator system. The heat recovery steam generator system can include the HRSG 204 of the coke oven system 102 (FIG. 2), and can be positioned to receive the flue gas from the coke oven. In some embodiments, the method also comprises powering the capture system via steam and/or electricity from the heat recovery steam generator system and/or the turbine fluidically coupled with a turbine. The turbine can include the turbine 308 (FIG. 3).

In some embodiments, the method 700 includes removing particulates from the flue gas by a baghouse. The baghouse can include the baghouse 208 of the coke oven system 102 (FIG. 2), and can be positioned between the coke oven and the induced draft fan. Removing the particulates from the flue gas can include removing solid particulates (i.e., dust) having a particle size below a threshold particle size by a set of filters. In some embodiments, the method 700 includes removing sulfur oxides, mercury, fly ash, and/or lime from the flue gas by a desulfurizer. The desulfurizer can include the desulfurizer 206 (FIG. 2) which is positioned between the coke oven and the induced draft fan. Removing the sulfur oxides, mercury, fly ash, and/or lime from the flue gas can include through addition of chemical absorbents.

In some embodiments, the method 700 further includes receiving recirculated flue gas by a combustion box from a point between the induced draft fan and the point where the capture system is fluidically coupled to the coke oven system. The combustion box can include the combustion box 402 (FIG. 4) of coke oven system 102, and can be positioned between the coke oven and the induced draft fan. The method 700 can also include receiving oxygen-enriched air or oxygen by the combustion box from an air separation unit fluidically coupled with the coke oven system and further combusting the recirculated flue gas by the combustion oven. The air separation unit can include the air separation unit 404 (FIG. 4) which can provide oxygen or oxygen-enriched air via the connector 408 (FIG. 4).

In some embodiments, the method 700 further includes providing oxygen or oxygen-enriched air to the coke oven by an air separation unit fluidically coupled with the coke oven system. The air separation unit can include the air separation unit 404 (FIG. 4).

### III. Conclusion

It will be apparent to those having skill in the art that changes may be made to the details of the above-described embodiments without departing from the underlying principles of the present disclosure. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination and placed into a respective independent clause. The other clauses can be presented in a similar manner.
1. A system for capturing greenhouse gases from flue gas produced by a coke oven, the system comprising:
   a coke oven system including:
      a coke oven configured to process coal and produce coke and a flue gas comprising carbon dioxide;
      an induced draft fan downstream of the coke oven, wherein the induced draft fan is configured to provide a vacuum to the coke oven and move the flue gas away from the coke oven; and
      a stack open to atmosphere and downstream of the induced draft fan;
   a capture system fluidically coupled to the coke oven system at a point between the coke oven and the stack, wherein the capture system is configured to remove carbon dioxide from the flue gas.
2. The system of any one of the clauses herein, wherein the point where the capture system is fluidically coupled to the coke oven system is between the induced draft fan and the stack.
3. The system of any one of the clauses herein, wherein the capture system comprises a flue gas booster fan positioned downstream from the point where the capture system is fluidically coupled to the coke oven system, the flue gas booster fan configured to move the flue gas from the coke oven system to the capture system.
4. The system of any one of the clauses herein, wherein the capture system comprises a flue gas pretreatment unit positioned downstream from the point where the capture system is fluidically coupled to the coke oven system and configured to process the flue gas to (i) cool the flue gas, and/or (ii) reduce a sulfur oxide concentration in the flue gas.
5. The system of any one of the clauses herein, wherein the capture system comprises a flue gas pretreatment unit configured to process the flue gas, the flue gas pretreatment unit comprising a flue gas quencher and/or a direct contact cooler.
6. The system of any one of the clauses herein, wherein the capture system comprises:
   an absorber unit configured to cause carbon dioxide from the flue gas to be absorbed in a solvent to produce treated flue gas; and
   a solvent regenerator unit configured to:
      provide the solvent to the absorber unit;
      receive the solvent including the absorbed carbon dioxide from the absorber unit; and
      cause the carbon dioxide to be separated from the absorbing solvent.
7. The system of any one of the clauses herein, wherein the capture system further comprises a carbon dioxide compression system configured to compress the carbon dioxide removed from the flue gas.
8. The system of any one of the clauses herein, wherein the capture system further comprises:
   a carbon dioxide compression system comprising a low-pressure compressor, a high-pressure compressor, and a dehydration unit positioned between the low-pressure compressor and the high-pressure compressor, wherein:
      the dehydration unit is configured to remove residual water from the carbon dioxide separated from the flue gas; and
      the low-pressure compressor and the high-pressure compressor are configured to compress the carbon dioxide to be transported via a pipeline.
9. The system of any one of the clauses herein, wherein:
   the capture system is fluidically coupled to the coke oven system by a tie-in that is switchable between a first configuration and a second configuration;
   the tie-in is configured to direct the flue gas from the coke oven to the capture system when the tie-in is in the first configuration; and
   the tie-in is configured to direct at least a portion of the flue gas from the coke oven to the stack of the coke oven system when the tie-in is in the second configuration.
10. The system of any one of the clauses herein, wherein the coke oven system further comprises a cooling dehydrator positioned between the induced draft fan and the point where the capture system is fluidically coupled to the coke oven system, the cooling dehydrator configured to cool the flue gas from the coke oven and/or reduce moisture in the flue gas from the coke oven.
11. The system of any one of the clauses herein, wherein the coke oven system further comprises a heat recovery steam generator system positioned to receive the flue gas from the coke oven and to recover heat from a stream of the flue gas.
12. The system of any one of the clauses herein, wherein the coke oven system further comprises a baghouse positioned between the coke oven and the induced draft fan, the baghouse configured to remove particulates from the flue gas.
13. The system of any one of the clauses herein, wherein the coke oven system further comprises a desulfurizer positioned between the coke oven and the induced draft fan, the desulfurizer configured to remove sulfur oxides, mercury, fly ash, and/or lime from the flue gas.
14. The system of any one of the clauses herein, wherein the system is configured to capture carbon dioxide from the flue gas with a recovery rate of at least 75%, at least 80%, at least 85%, at least 90%, or at least 95%.
15. The system of any one of the clauses herein, wherein the coke oven system further comprises a combustion box positioned between the coke oven and the induced draft fan, the combustion box configured to:
   receive recirculated flue gas from a point between the induced draft fan and the point where the capture system is fluidically coupled to the coke oven system,
   receive oxygen-enriched air or oxygen from an air separation unit fluidically coupled with the coke oven system, and
   further combust the recirculated flue gas.
16. The system of any of the clauses herein, wherein the coke oven system further comprises an air separation unit fluidically coupled with the coke oven system, the air separation unit configured to provide oxygen or oxygen-enriched air to the coke oven.
17. The system of any one of the clauses herein, wherein:
   the coke oven system further comprises a heat recovery steam generator system positioned to receive the flue gas from the coke oven and to recover heat from a stream of the flue gas,
   the heat recovery steam generator system is fluidically coupled with a turbine, and
   the capture system is configured to be powered by steam and/or electricity from the heat recovery steam generator system and/or the turbine.
18. The system of any one of the clauses herein, wherein the capture system further comprises:
   a flue gas booster fan positioned downstream from the point where the capture system is fluidically coupled to the coke oven system, the flue gas booster fan configured to move the flue gas from the coke oven system to the capture system;
   a flue gas pretreatment unit downstream of the flue gas booster fan and configured to process the flue gas to (i) cool a temperature of the flue gas and/or (ii) reduce a sulfur oxide concentration of the flue gas;
   an absorber unit downstream of the flue gas pretreatment unit, wherein the absorber is configured to cause carbon dioxide in the flue gas to be absorbed in a solvent to produce treated flue gas;
   a solvent regenerator unit downstream of the absorber unit, wherein the solvent regenerator is configured to:
      provide the solvent to the absorber unit;
      receive the solvent including the absorbed carbon dioxide from the absorber unit; and
      cause the carbon dioxide to be separated from the absorbing solvent; and
   a carbon dioxide compression system downstream of the solvent regenerator unit configured to compress the carbon dioxide separated from the absorbing solvent via the solvent regenerator.
19. The system of any one of the clauses herein, wherein the coke oven system further comprises:
   a cooling dehydrator positioned between the induced draft fan and the point where the capture system is fluidically coupled to the coke oven system, the cooling dehydrator configured to cool down the flue gas from the coke oven and/or reduce moisture in the flue gas from the coke oven;
   a heat recovery steam generator system positioned to receive the flue gas from the coke oven and configured to recover heat from a stream of the flue gas;
   a baghouse positioned between the coke oven and the induced draft fan, the baghouse configured to remove particulates from the flue gas; and
   a desulfurizer positioned between the coke oven and the induced draft fan, the desulfurizer configured to remove sulfur oxides, mercury, fly ash, and/or lime from the flue gas.
20. A method for capturing greenhouse gases from flue gas produced by a coke oven, the method comprising:
   processing coal via the coke oven system to produce coke and a flue gas comprising carbon dioxide;
   moving the flue gas away from the coke oven via an induced draft fan providing a vacuum to the coke oven, wherein the induced draft fan is positioned downstream of the coke oven and upstream from a stack that is open to atmosphere; and
   removing carbon dioxide from the flue gas via a capture system fluidically coupled to the coke oven system at a point between the coke oven and the stack.
21. The method of any one of the clauses herein, wherein the point where the capture system is fluidically coupled to the coke oven system is between the induced draft fan and the stack.
22. The method of any one of the clauses herein, further comprising moving, via a flue gas booster fan, the flue gas from the coke oven system to the capture system, wherein the flue gas booster fan is positioned downstream from the point where the capture system is fluidically coupled to the coke oven system.
23. The method of any one of the clauses herein, further comprising processing, by a flue gas pretreatment unit positioned downstream from the point where the capture system is fluidically coupled to the coke oven system, the flue gas to (i) cool the flue gas, and (ii) reduce sulfur oxide concentration of the flue gas a flue gas quencher or a direct contact cooler.
24. The method of any one of the clauses herein, further comprising processing the flue gas by a flue gas pretreatment unit comprising a flue gas quencher and/or a direct contact cooler.
25. The method of any one of the clauses herein, further comprising:
   cause, by an absorber unit, carbon dioxide from the flue gas to be absorbed in a solvent to produce treated flue gas; and
   providing, by a solvent regenerator, the solvent to the absorber unit;
   receiving, by the solvent regenerator, the solvent including the absorbed carbon dioxide from the absorber unit; and
   causing, by the solvent regenerator, the carbon dioxide to be separated from the absorbing solvent.
26. The method of any one of the clauses herein, further comprising compressing, by a carbon dioxide compression system, the carbon dioxide removed from the flue gas.
27. The method of any one of the clauses herein, further comprising compressing, by a carbon dioxide compression system comprising a low-pressure compressor, a high-pressure compressor, and a dehydration unit positioned between the low-pressure compressor and the high-pressure compressor, the compressing comprising:
   removing, by the dehydration unit, residual water from the carbon dioxide separated from the flue gas; and
   compressing, by the low-pressure compressor and the high-pressure compressor, the carbon dioxide to be transported via a pipeline.
28. The method of any one of the clauses herein, further comprising:
   directing, by a tie-in that fluidically couples the capture system to the coke oven system, the flue gas from the coke oven to the capture system when the tie-in is in a first configuration;
   directing, by the tie-in, the flue gas from the coke oven to the stack when the tie-in is in a second configuration, wherein the tie-in is switchable between the first configuration and the second configuration.
29. The method of any one of the clauses herein, further comprising cooling, by a cooling dehydrator, the flue gas from the coke oven and/or reduce moisture in the flue gas from the coke oven, wherein the cooling dehydrator is positioned between the induced draft fan and the point where the capture system is fluidically coupled to the coke oven system.
30. The method of any one of the clauses herein, further comprising recovering, by a heat recovery steam generator system, heat from a stream of the flue gas, wherein the heat recovery steam generator system is positioned to receive the flue gas from the coke oven.
31. The method of any one of the clauses herein, further comprising removing, by a baghouse positioned between the coke oven and the induced draft fan, particulates from the flue gas.
32. The method of any one of the clauses herein, further comprising removing, by a desulfurizer positioned between the coke oven and the induced draft fan, sulfur oxides, mercury, fly ash, and/or lime from the flue gas.
33. The method of any one of the clauses herein, wherein the method is configured to capture carbon dioxide from the flue gas with a recovery rate of at least 75%, at least 80%, at least 85%, at least 90% or at least 95%.
34. The method of any one of the clauses herein, further comprising:
   receiving, by a combustion box positioned between the coke oven and the induced draft fan, recirculated flue gas from a point between the induced draft fan and the point where the capture system is fluidically coupled to the coke oven system,
   receiving, by the combustion box, oxygen-enriched air or oxygen from an air separation unit fluidically coupled with the coke oven system, and
   further combusting, by the combustion box, the recirculated flue gas.
35. The method of any of the clauses herein, further comprising providing oxygen or oxygen-enriched air to the coke oven by an air separation unit fluidically coupled with the coke oven system.
36. The method of any one of the clauses herein, further comprising:
   recovering heat from a stream of the flue gas by a heat recovery steam generator system positioned to receive the flue gas from the coke oven, the heat recovery steam generator system fluidically coupled with a turbine, and
   powering the capture system by steam and/or electricity from the heat recovery steam generator system and/or the turbine.
37. The method of any one of the clauses herein, further comprising:
   moving, by a flue gas booster fan positioned downstream from the point where the capture system is fluidically coupled to the coke oven system, the flue gas from the coke oven system to the capture system;
   processing, by a flue gas pretreatment unit downstream of the flue gas booster fan and configured to (i) cool down temperature of the flue gas, and/or (ii) reduce a sulfur oxide concentration of the flue gas;
   causing, by an absorber unit downstream of the flue gas pretreatment unit, carbon dioxide in the flue gas to be absorbed in a solvent to produce treated flue gas;
   providing, by a solvent regenerator downstream of the absorber unit, the solvent to the absorber unit;
   receiving, by the solvent regenerator, the solvent including the absorbed carbon dioxide from the absorber unit;
   causing, by the solvent regenerator, the carbon dioxide to be separated from the absorbing solvent; and
   compressing, by a carbon dioxide compression system downstream of the solvent regenerator unit, the carbon dioxide removed from the flue gas.
38. The method of any one of the clauses herein, further comprising:
   cooling down, by a cooling dehydrator, the flue gas from the coke oven and/or reduce moisture in the flue gas from the coke oven, wherein the cooling dehydrator is positioned between the induced draft fan and the point where the capture system is fluidically coupled to the coke oven system;
   recovering, by a heat recovery steam generator system, heat from a stream of the flue gas, wherein the heat recovery steam generator system is positioned to receive the flue gas from the coke oven;
   removing, by a baghouse positioned between the coke oven and the induced draft fan, particulates from the flue gas; and
   removing, by a desulfurizer positioned between the coke oven and the induced draft fan, sulfur oxides, mercury, fly ash, and/or lime from the flue gas.
39. A system for capturing greenhouse gases from flue gas produced by a coke oven, the system comprising:
   a coke oven system including:
      a coke oven configured to process coal to produce coke and a flue gas comprising carbon dioxide; and
      a stack open to atmosphere and downstream of the coke oven; and
   a capture system fluidically coupled to the coke oven system at a point between the coke oven and the stack, wherein the capture system is configured to remove carbon dioxide from the flue gas.

What is claimed is:

1. A system for capturing greenhouse gases from flue gas produced by a coke oven, the system comprising:
a coke oven system including:
a coke oven configured to process coal and produce coke and a flue gas comprising carbon dioxide;
an induced draft fan downstream of the coke oven, wherein the induced draft fan is configured to provide a vacuum to the coke oven and move the flue gas away from the coke oven; and
a stack open to atmosphere and downstream of the induced draft fan;
a capture system fluidically coupled to the coke oven system at a point between the coke oven and the stack, wherein the capture system is configured to remove carbon dioxide from the flue gas.

2. The system of claim 1, wherein the point where the capture system is fluidically coupled to the coke oven system is between the induced draft fan and the stack.

3. The system of claim 1, wherein the capture system comprises a flue gas booster fan positioned downstream from the point where the capture system is fluidically coupled to the coke oven system, the flue gas booster fan configured to move the flue gas from the coke oven system to the capture system.

4. The system of claim 1, wherein the capture system comprises a flue gas pretreatment unit positioned downstream from the point where the capture system is fluidically coupled to the coke oven system and configured to process the flue gas to (i) cool the flue gas, and/or (ii) reduce a sulfur oxide concentration of the flue gas.

5. The system of claim 1, wherein the capture system comprises a flue gas pretreatment unit configured to process the flue gas, the flue gas pretreatment unit comprising a flue gas quencher and/or a direct contact cooler.

6. The system of claim 1, wherein the capture system comprises:
an absorber unit configured to cause carbon dioxide from the flue gas to be absorbed in a solvent to produce treated flue gas; and
a solvent regenerator unit configured to:
provide the solvent to the absorber unit;
receive the solvent including the absorbed carbon dioxide from the absorber unit; and
cause the carbon dioxide to be separated from the absorbing solvent.

7. The system of claim 1, wherein the capture system further comprises a carbon dioxide compression system configured to compress the carbon dioxide removed from the flue gas.

8. The system of claim 1, wherein the capture system further comprises:
a carbon dioxide compression system comprising a low-pressure compressor, a high-pressure compressor, and a dehydration unit positioned between the low-pressure compressor and the high-pressure compressor, wherein:
the dehydration unit is configured to remove residual water from the carbon dioxide separated from the flue gas; and
the low-pressure compressor and the high-pressure compressor are configured to compress the carbon dioxide to be transported via a pipeline.

9. The system of claim 1, wherein:
the capture system is fluidically coupled to the coke oven system by a tie-in that is switchable between a first configuration and a second configuration;
the tie-in is configured to direct the flue gas from the coke oven to the capture system when the tie-in is in the first configuration; and
the tie-in is configured to direct at least a portion of the flue gas from the coke oven to the stack of the coke oven system when the tie-in is in the second configuration.

10. The system of claim 1, wherein the coke oven system further comprises a cooling dehydrator positioned between the induced draft fan and the point where the capture system is fluidically coupled to the coke oven system, the cooling dehydrator configured to cool the flue gas from the coke oven and/or reduce moisture in the flue gas from the coke oven.

11. The system of claim 1, wherein the coke oven system further comprises a heat recovery steam generator system positioned to receive the flue gas from the coke oven and to recover heat from a stream of the flue gas.

12. The system of claim 1, wherein the coke oven system further comprises a baghouse positioned between the coke oven and the induced draft fan, the baghouse configured to remove particulates from the flue gas.

13. The system of claim 1, wherein the coke oven system further comprises a desulfurizer positioned between the coke oven and the induced draft fan, the desulfurizer configured to remove sulfur oxides, mercury, fly ash, and/or lime from the flue gas.

1. The system of claim 1, wherein the system is configured to capture carbon dioxide from the flue gas with a recovery rate of at least 75%, at least 80%, at least 85%, at least 90%, or at least 95%.

2. The system of claim 1, wherein the coke oven system further comprises a combustion box positioned between the coke oven and the induced draft fan, the combustion box configured to:
receive recirculated flue gas from a point between the induced draft fan and the point where the capture system is fluidically coupled to the coke oven system,
receive oxygen-enriched air or oxygen from an air separation unit fluidically coupled with the coke oven system, and
further combust the recirculated flue gas.

3. The system of claim 1, wherein the coke oven system further comprises an air separation unit fluidically coupled with the coke oven, the air separation unit configured to provide oxygen or oxygen-enriched air to the coke oven and/or a common tunnel extending to the coke oven.

4. The system of claim 1, wherein:
the coke oven system further comprises a heat recovery steam generator system positioned to receive the flue gas from the coke oven and to recover heat from a stream of the flue gas,
the heat recovery steam generator system is fluidically coupled with a turbine, and
the capture system is configured to be powered by steam and/or electricity from the heat recovery steam generator system and/or the turbine.

5. The system of claim 1, wherein the capture system further comprises:
a flue gas booster fan positioned downstream from the point where the capture system is fluidically coupled to the coke oven system, the flue gas booster fan configured to move the flue gas from the coke oven system to the capture system;
a flue gas pretreatment unit downstream of the flue gas booster fan and configured to process the flue gas to (i) cool a temperature of the flue gas and/or (ii) reduce a sulfur oxide concentration in the flue gas;
an absorber unit downstream of the flue gas pretreatment unit, wherein the absorber is configured to cause carbon dioxide in the flue gas to be absorbed in a solvent to produce treated flue gas;
a solvent regenerator unit downstream of the absorber unit, wherein the solvent regenerator is configured to:
provide the solvent to the absorber unit;
receive the solvent including the absorbed carbon dioxide from the absorber unit; and
cause the carbon dioxide to be separated from the absorbing solvent; and
a carbon dioxide compression system downstream of the solvent regenerator unit configured to compress the carbon dioxide separated from the absorbing solvent via the solvent regenerator.

6. The system of claim 1, wherein the coke oven system further comprises:
a cooling dehydrator positioned between the induced draft fan and the point where the capture system is fluidically coupled to the coke oven system, the cooling dehydrator configured to cool down the flue gas from the coke oven and/or reduce moisture in the flue gas from the coke oven;
a heat recovery steam generator system positioned to receive the flue gas from the coke oven and configured to recover heat from a stream of the flue gas;
a baghouse positioned between the coke oven and the induced draft fan, the baghouse configured to remove particulates from the flue gas; and
a desulfurizer positioned between the coke oven and the induced draft fan, the desulfurizer configured to remove sulfur oxides, mercury, fly ash, and/or lime from the flue gas.

7. A system for capturing greenhouse gases from flue gas produced by a coke oven, the system comprising:
a coke oven system including:
a coke oven configured to process coal to produce coke and a flue gas comprising carbon dioxide; and
a stack open to atmosphere and downstream of the coke oven; and
a capture system fluidically coupled to the coke oven system at a point between the coke oven and the stack, wherein the capture system is configured to remove carbon dioxide from the flue gas.
